(19) United States
(12) Patent Application Publication
(10) Pub. No.: US 2026/0339659 A1
(43) Pub. Date: Oct. 29, 2026

(54) SYSTEM AND METHOD FOR GENERATING ARCHITECTURE DIAGRAMS FROM CODE REPOSITORIES

(71) Applicant: Kinaxis Inc., Ottawa (CA)

(72) Inventors: Jean-Francois Dubeau, Gatineau (CA); Arslan Shahid, Ottawa (CA); Leila Mousapour, Hamilton (CA); Colton Mackenzie Donkersgoed, Hamilton (CA)

(73) Assignee: Kinaxis Inc., Ottawa (CA)

(21) Appl. No.: 19/651,921

(22) Filed: Apr. 20, 2026

Related U.S. Application Data
(60) Provisional application No. 63/794,003, filed on Apr. 24, 2025.

(51) Int. Cl. G06F 8/73; G06F 8/35

(52) U.S. Cl. CPC G06F 8/73; G06F 8/35

(57) ABSTRACT

An automated system for generating and maintaining up-to-date architectural diagram codes that effectively combines continuous code monitoring, resource identification, resource annotation, constraint-based diagram generation, and standardized formatting to provide accurate, consistent, and efficient documentation of complex software architectures. This automated approach minimizes manual effort, reduces the risk of errors, and ensures that architectural diagrams remain current with the evolving codebase, thereby enhancing overall change management and communication within development teams.

This application claims priority on U.S. Ser. No. 63/794,003 filed on Apr. 24, 2025, which is incorporated herein in its entirety, by reference.

### BACKGROUND

Maintaining accurate software architecture documentation is difficult as systems evolve into distributed ecosystems spanning multiple repositories. Conventional approaches rely on manual updates to diagrams and other artifacts to reflect code changes, which is time-consuming and error-prone. As projects scale and contributors increase, documentation commonly diverges from implementation, hindering communication, complicating design decisions, and increasing risk when modifying or scaling the system.

Various tools attempt to automate portions of design analysis and validation. Examples include static analysis of code structure; extraction of requirements from text; runtime instrumentation to capture execution paths and dependencies; graph-based rule checking using intermediate representations; and model-driven techniques that generate code from abstract designs. However, these approaches typically address isolated concerns and often assume a single-repository context.

There is much complexity and many challenges associated with managing the architectural integrity of a growing and evolving codebase, particularly in the absence of a streamlined, automated method to assess the architectural impact of code changes committed across multiple repositories. This problem manifests through several issues:

Increased Risk of Architectural Degradation: Without an automated assessment, code changes can inadvertently degrade a system's architectural quality, leading to technical debt, increased maintenance costs, and reduced system performance and scalability.

Inefficiencies in Code Review Process: The manual process of assessing architectural impact is time-consuming, error-prone, and inconsistent. Reviewers must manually trace dependencies and potential impacts, slowing down a development cycle and delaying deployment of new features and bug fixes.

Lack of Visibility and Traceability: Developers and architects lack a unified view of how changes in one repository affect others, leading to a siloed approach that obscures the broader impact of individual commits and hinders effective collaboration.

Difficulty in Maintaining Consistent Architectural Standards: As the number of repositories and contributors increases, maintaining consistent architectural standards becomes more challenging. Without an automated system to enforce and monitor these standards, deviations that compromise the system's overall integrity and performance are more likely.

A need remains for an automated, unified assessment of architectural integrity across distributed repositories, including visibility into how a change in one repository affects system-level architecture and cross-repository dependencies. In practice, architectural impact analysis and standards enforcement are still frequently performed manually, leading to inconsistent governance and delayed identification of technical debt. Absent continuous validation between distributed codebases and their architectural representations, organizations may incur higher maintenance costs and reduced architectural quality as system complexity increases.

### BRIEF SUMMARY

Systems and methods disclosed herein provide automation of diagram generation, enhanced accuracy and consistency; and facilitate improved change management. By automating the generation of architectural diagrams, systems and methods disclosed herein eliminate the need for manual creation and updates, which are time-consuming and error-prone. Continuous updates provided by systems and methods disclosed herein, guarantee that the architectural documentation remains consistent with the codebase. In addition, systems and methods disclosed herein allow for automating the creation of architectural diagrams, which enable the detection of code changes that result in deviations from the existing architecture.

Systems and methods disclosed herein, maintain accurate and up-to-date architectural diagrams for complex software systems, where the code is often spread across multiple repositories. Additionally, such automated systems and methods not only save time and reduces errors, but also enable detection of deviations between the code and the architectural diagrams when new code changes are introduced.

The technical approach of embedding training data from a tree-based model into a vector space, where dimensions correspond to specific decision points, enables the definition of time series distance through cosine similarity. This structural transformation facilitates the application of a Hierarchical Navigable Small World index to perform approximate nearest neighbor searches with significantly reduced computational overhead compared to conventional leaf-tracking methods. By leveraging this indexing strategy, the system efficiently identifies the most similar historical vectors to construct a discrete probability distribution, thereby generating accurate prediction intervals without the prohibitive latency and resource consumption associated with processing millions of time series using traditional autoregressive or Bayesian techniques.

Furthermore, the derivation of quantiles from the generated probability distribution allows for the construction of tradeoff curves and objective functions that support complex optimization tasks. This capability permits the simultaneous optimization of product quantities across multiple locations using a solver constrained by maximum available inventory, a process that remains computationally tractable even at scale. The integration of vector-based similarity search with tree-based model outputs provides a distinct technical advantage by delivering probabilistic forecasts and actionable optimization parameters in a manner that is both faster and more resource-efficient than existing methods that fail to balance computational speed with the accuracy required for large-scale time series forecasting.

In one aspect, a computing apparatus is provided, that includes a processor. The computing apparatus also includes a memory storing instructions that, when executed by the processor, configure the apparatus to: receive one or more user code files; identify relevant code from the one or more user code files; identify one or more architectural resources; annotate the one or more architectural resources; and generate an architecture diagram code.

When identifying the relevant code from the one or more user code files, the instructions may further configure the apparatus to: identify one or more code snippets, from the one or more code files, that contain one or more architectural components; and filter out irrelevant code.

When identifying the one or more architectural resources, the instructions may further configure the apparatus to cross-reference the relevant code with a list of all architectural resources.

When annotating the one or more architectural resources, the instructions may further configure the apparatus to apply a set of annotation rules to the one or more architectural resources to obtain one or more annotated architectural resources.

When generating the architecture diagram code, the instructions may further configure the apparatus to: include the relevant code; apply predefined diagram constraints to the one or more annotated architectural resources; apply a set of diagram syntax rules for creation of the architecture diagram code; and use example pairs of user code and corresponding diagram code in assisting a Large Language Model to generate the architecture diagram code. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive one or more user code files; identify relevant code from the one or more user code files; identify one or more architectural resources; annotate the one or more architectural resources; and generate an architecture diagram code.

When identifying the relevant code from the one or more user code files, the instructions may further configure the computer to identify one or more code snippets, from the one or more code files, that contain one or more architectural components, and filter out irrelevant code.

When identifying the one or more architectural resources, the computer may be further configured to cross-reference the relevant code with a list of all architectural resources.

When annotating the one or more architectural resources, the instructions may further configure the computer to apply a set of annotation rules to the one or more architectural resources.

When generating the architecture diagram code, the instructions may further configure the computer to: include the relevant code; apply predefined diagram constraints to the one or more annotated architectural resources; apply a set of diagram syntax rules for creation of the architecture diagram code; and use example pairs of user code and corresponding diagram code in assisting a Large Language Model generate the architecture diagram code. Other technical features may be readily apparent to one skilled in the art from the following figures, descriptions, and claims.

In one aspect, a computer-implemented method is provided. The method includes: receiving, by a processor, one or more user code files; identifying, by the processor, relevant code from the one or more user code files; identifying, by the processor, one or more architectural resources; annotating, by the processor, the one or more architectural resources; and generating, by the processor, an architecture diagram code.

The computer-implemented method may also include where identifying the relevant code from the one or more user code files includes: identifying, by the processor, one or more code snippets, from the one or more code files, that contain one or more architectural components; and filtering out, by the processor, irrelevant code.

The computer-implemented method may also include where identifying the one or more architectural resources includes cross-referencing, by the processor, the relevant code with a list of all architectural resources.

The computer-implemented method may also include where annotating the one or more architectural resources, further includes applying, by the processor, a set of annotation rules to the one or more architectural resources.

The computer-implemented method may also include where generating the architecture diagram code includes: receiving, by the processor, the relevant code; applying, by the processor, predefined diagram constraints to the one or more annotated architectural resources; applying, by the processor, a set of diagram syntax rules for creation of the architecture diagram code; and using, by the processor, example pairs of user code and corresponding diagram code in assisting a Large Language Model generate the architecture diagram code. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for generating architecture diagrams from code repositories in accordance with one embodiment.

FIG. 2 illustrates a block diagram for creation of an architectural diagram in accordance with one embodiment.

FIG. 3 illustrates a block diagram for identifying relevant code in accordance with one embodiment.

FIG. 4 illustrates a block diagram for identifying architectural resources in accordance with one embodiment.

FIG. 5 illustrates a block diagram for annotating architectural resources in accordance with one embodiment.

FIG. 6 illustrates a block diagram for generating architecture diagram codes in accordance with one embodiment.

FIG. 7A illustrates an example of an input code.

FIG. 7B illustrates an example of an output diagram code based on the input code shown in FIG. 7A.

FIG. 7C illustrates an example of a container view of an architecture diagram generated from the output diagram code shown in FIG. 7B.

FIG. 7D illustrates an example of a component view of an architecture diagram generated from the output diagram code shown in FIG. 7B.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

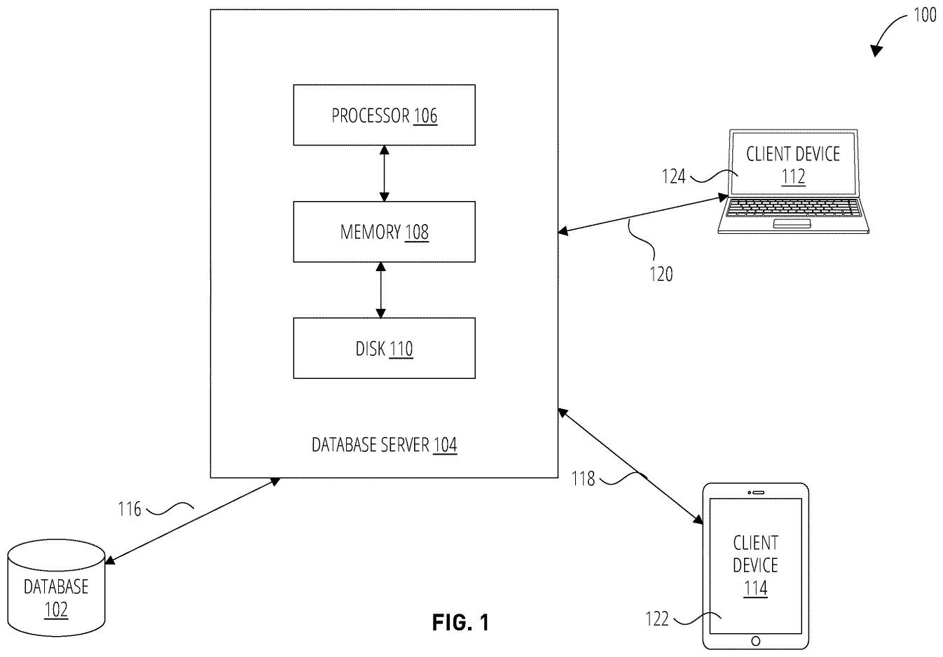

FIG. 1 illustrates an example of a system 100 for generating architecture diagrams from code repositories.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a TypeScript algorithm. A deterministic process may include a core algorithm the results of which may not be serializable, for example if they are in-memory C++objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

Systems and methods disclosed herein leverage Large Language Models (LLMs) to automate generation and maintenance of up-to-date architectural diagrams for complex software systems. Relevant information can be extracted directly from a codebase, which is distributed across multiple repositories. This data can be used to create accurate and current architectural representations of the system.

The advantages of this approach are manifold. By leveraging Large Language Models (LLMs) for automated generation and maintenance of architectural diagrams, documentation is always accurate and up-to-date, significantly reducing the time and effort required for manual updates. This enhances overall efficiency and minimizes the risk of human error. Continuous updates maintain consistency with the codebase, facilitating better communication among team members and stakeholders. Additionally, there is improved change management by promptly detecting deviations caused by code changes, thereby helping in early identification and mitigation of potential issues.

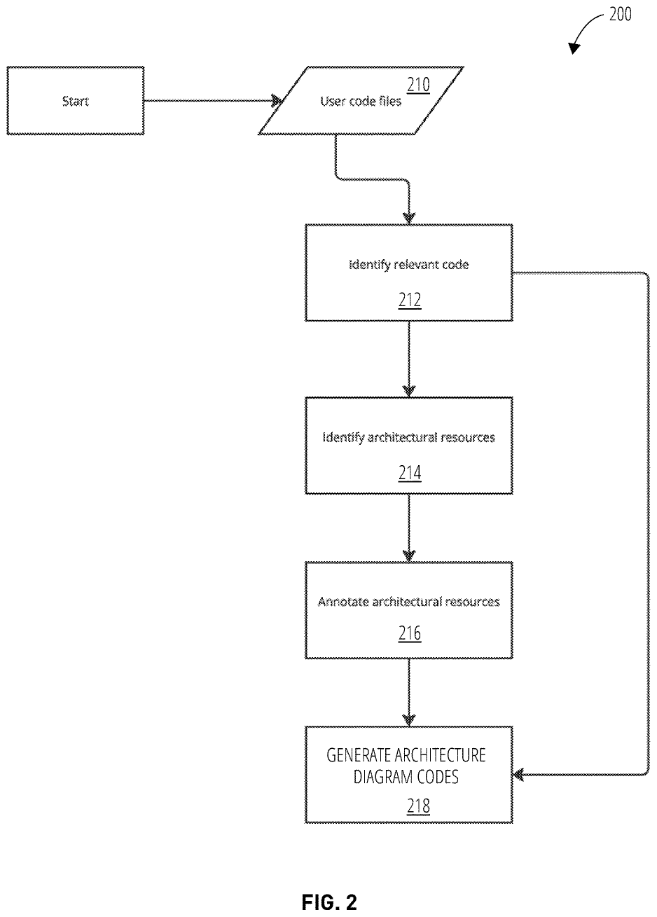

Systems and methods disclosed herein can include a number of elements, such as identification of relevant code, identification of architectural resources to be added to an architectural diagram, annotation of architectural resources, and generation of the architectural diagram. These are described further in FIG. 2-FIG. 6.

FIG. 2 illustrates a block diagram 200 for creation of an architectural diagram in accordance with one embodiment.

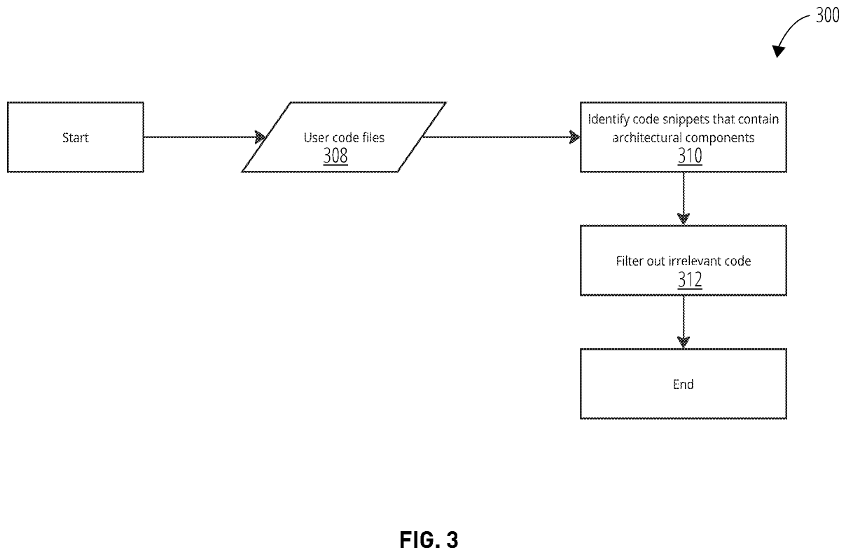

User code files (210) are used as input to identify relevant code at block 212. At this step, there can be implementation of continuous monitoring and analysis of code repositories. The code can be parsed using Large Language Models (LLMs) to identify code segments pertinent to architectural diagrams. A subroutine for identifying relevant code is illustrated and further discussed in FIG. 3.

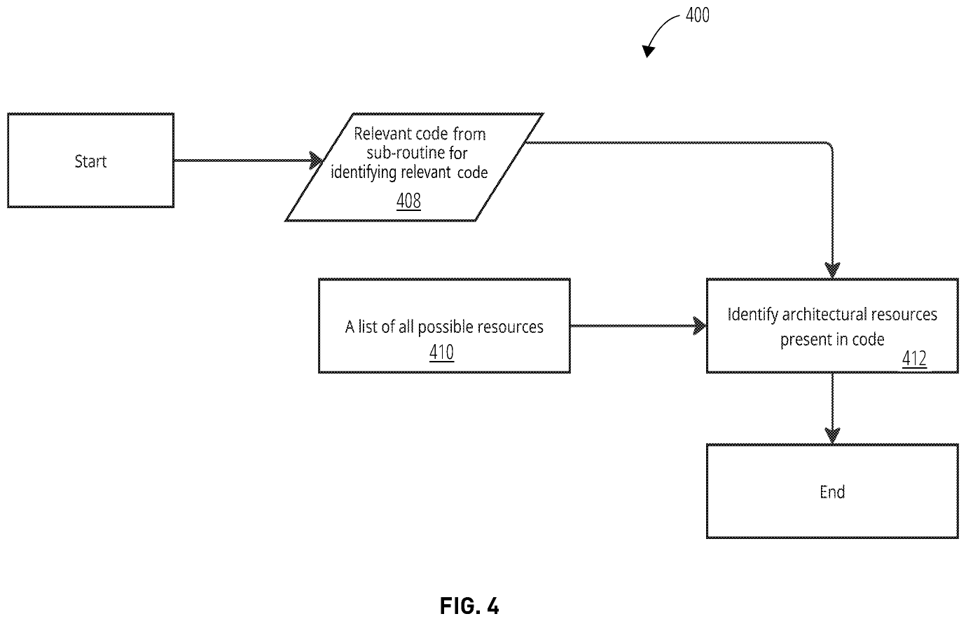

At bock 214, architectural resources that are to be added to an architectural diagram, are identified. Here, a list of potential resources can be compiled. Extracted data can be cross-referenced using LLMs to ensure that all necessary architectural resources that should be included in the diagram are identified. A subroutine for adding architectural resources is illustrated and further discussed in FIG. 4.

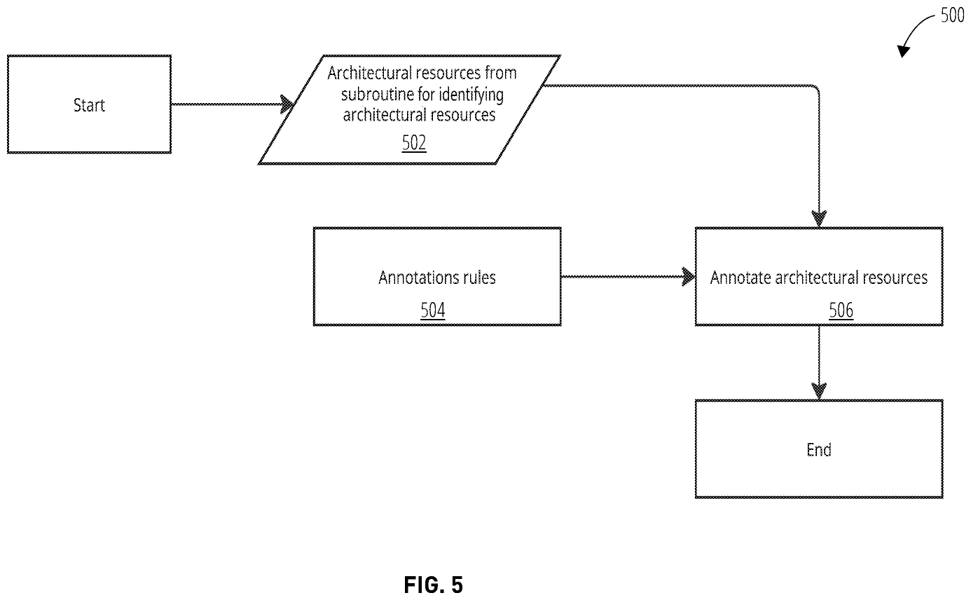

At bock 216, architectural resources are annotated. At this step, a set of annotation rules can be developed for architectural resources. These annotation rules can be applied to ensure accurate labeling of resources. A subroutine for annotating architectural resources is illustrated and further discussed in FIG. 5.

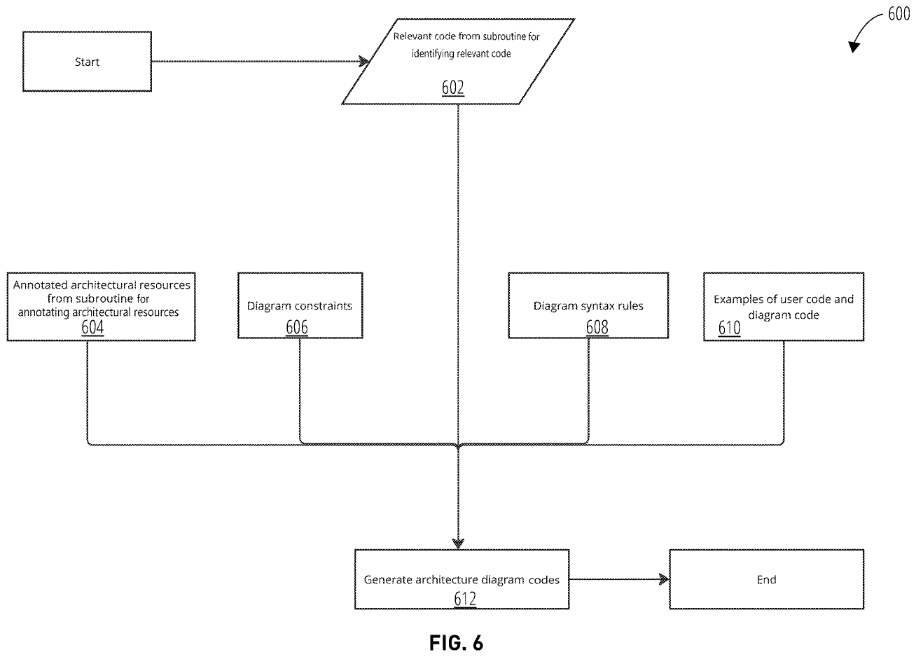

Finally, At bock 218, an architecture diagram code can be generated. In this final step, annotated architectural resources identified in the previous steps, can be incorporated. Predefined diagram constraints can then be applied to the identified resources. Syntax rules for creating diagram code in a specific format can be followed. An example of a specific format that can be used is a Domain Specific Language (DSL). Furthermore, example pairs of user code and their corresponding diagram code can be utilized to aid LLMs in accurately generating the diagram code. A subroutine for generating an architectural diagram code is illustrated and further discussed in FIG. 6.

FIG. 3 illustrates a block diagram 300 for identifying relevant code in accordance with one embodiment.

Systems and methods disclosed herein, begin by continuously monitoring multiple code repositories. User code files (308) are used as input to identify code snippets that contain architectural components at block 310. Using Large Language Models (LLMs), the code can be scanned and parsed to identify key code segments that contain information about architectural elements such as modules, services, databases, containers, pods, etc. At block 312, irrelevant code is filtered out. This step ensures that only relevant code is passed to the next step to allow it to focus on important information.

For example, a Kubernetes deployment manifest is relevant code segment as shown below:
apiVersion: apps/v1
   kind: Deployment
   metadata:
   name: whalesay
   labels:
      app: whalesay
         . . .

The above code is important as it results in an application and deployment resource named “whalesay” being created.

An example of irrelevant code segment:
#Function to add two numbers
def add_numbers(a, b):
   return a+b

This is irrelevant as this code contains business logic that runs inside a resource but does not impact the architecture diagram.

The process of using LLMs to parse user code files and identify specific snippets containing architectural components while filtering out irrelevant code, automates the extraction of meaningful structural data from raw source code across multiple repositories. Such an approach significantly reduces the manual effort required to sift through codebases and minimizes human error in identifying critical architectural elements, ensuring that only relevant data is processed for diagram generation.

The LLM can distinguish between architectural components and standard business logic in ambiguous code scenarios. For example, the system can cross-reference code against a predefined list of known architectural resource types (pods, deployments, services, ingresses, etc.), so that even in ambiguous cases, only code that maps to a recognized resource type is retained. Business logic that does not declare or configure a known resource is filtered out before reaching resource identification.

Mechanisms can be put in place to handle false positives or negatives in the filtering process. The multi-step pipeline acts as successive validation stages—block 214 in FIG. 2 cross-references filtered code against a comprehensive list of all possible architectural resource types, catching items that were incorrectly included or missed in the initial filtering step.

In terms of a filtering criteria customized by users for specific architectural patterns, the system relies on a predefined list of architectural resource types and annotation rules that can be extended or modified leveraging user-facing configurations.

FIG. 4 illustrates a block diagram 400 for identifying architectural resources in accordance with one embodiment.

Once the relevant code is identified (see for example, block diagram 300 in FIG. 3), the next step can involve identifying the resources that need to be represented in the architectural diagram. The system can cross-reference a list of all possible resources (410) with the extracted data from the previous step to ensure that all necessary components are included, at block 412. This step can also leverage LLM and can ensure that the diagram will be complete and includes all architectural components. In the context of Kubernetes resources, these may include pods, replicasets, deployments, services, StatefulSets, Jobs, CronJobs, Ingresses, DaemonSets, persistentvolumes, persistentvolumeclaims, serviceaccounts, secrets, configmaps, BackendTLSPolicy, HTTPRoute, etc.

Continuing from the above example:
apiVersion: apps/v1
   kind: Deployment
   metadata:
   name: whalesay
   labels:
      app: whalesay
         . . .

This step should identify a container and deployment for “whalesay” application as architectural resources.

As shown in FIG. 4, cross-referencing is used to identify relevant code with a comprehensive list of all architectural resources to ensure that every necessary component distributed across different repositories is included in the analysis. Such an approach ensures a unified and complete view of the system architecture, preventing siloed perspectives and accurately capturing dependencies between components located in separate code repositories.

Version conflicts or naming collisions can occur when cross-referencing resources across repositories. This can be handled by annotating each identified resource with its type tag (e.g., “Kubernetes—deploy”) and associating it with its metadata (name, labels, relationships) in block 216 (of FIG. 2) so that resources with the same name (but different types or from different repositories) are disambiguated through their annotation labels and the contextual relationships (e.g., service→deployment routing) established during diagram generation in block 218 (of FIG. 2)/

With regards to a latency impact of cross-referencing resources in very large distributed systems, upstream filtering (shown in FIG. 3) reduces the volume of code passed to the cross-referencing step, which inherently limits the processing scope. This significantly reduces the latency impact of cross-referencing resources in very large distributed systems.

In addition, real-time updates are supported as new repositories are added to the ecosystem. As new repositories are added with minimal integration work, they can be connected to the system to allow continuous monitoring and analysis of these new code repositories.

FIG. 5 illustrates a block diagram 500 for annotating architectural resources in accordance with one embodiment.

The process of annotating architectural resources ensures accurate representation of these elements within architectural diagrams. This process may begin with the development of a comprehensive set of annotation rules (504), which may be designed to provide clear and consistent guidelines for labeling various architectural components.

With the relevant architectural resources identified from the previous step (for example, see block diagram 400 in FIG. 4), the system can then apply these annotation rules (504) to annotate the architectural resources at block 506.

As an example, a Kubernetes deployment resource can be tagged as:
“Kubernetes—deploy”

FIG. 6 illustrates a block diagram 600 for generating architecture diagram codes in accordance with one embodiment.

In this final step, annotated architectural resources (604) identified previously (for example, at block diagram 500 in FIG. 5), can be incorporated. Predefined diagram constraints 606 can then be applied to the identified resources. Syntax rules (608) for creating diagram code in a specific format can be followed. An example of a specific format that can be used is a Domain Specific Language (DSL). Furthermore, example pairs of user code and their corresponding diagram code (610) can be utilized to aid LLMs in accurately generating the diagram code.

With the relevant resources identified and annotated, the system may then pass relevant user code 602 (obtained, for example, using block diagram 300 in FIG. 3), predefined diagram constraints 606, syntax rules 608 and example pairs of user code and corresponding diagram code 610 to an LLM to construct the architecture diagram codes at block 612. The diagram constraints 606 can include specific rules and guidelines about how elements should be represented and their relationships. Applying syntax rules 608 can ensure that the generated diagram adheres to a specific format, such as Domain Specific Language(DSL), Unified Modeling Language (UML) or other organization-specific standards. The example pairs of user code and corresponding diagram code 610 can assist a large language model (LLMs) in the understanding of translation process.

In some embodiments, a system is provided that generates architecture diagram code by applying predefined constraints and syntax rules, such as a Domain Specific Language (DSL), using example pairs of user code and corresponding diagram code to guide the LLM. Generating code, rather than static images, allows for dynamic updates, version control integration, and easier maintenance of diagrams as the underlying code evolves, ensuring the documentation remains synchronized with the system.

Examples of DSLs that can be supported include Domain Specific Language (DSL) and Unified Modeling Language (UML); the example output can use Structurizr DSL. In addition, configurable syntax rules and example pairs can be used, suggesting adaptability to other diagramming languages by updating those inputs.

Generated diagram code can be ensured to adhere strictly to predefined constraints without hallucination, by providing the LLM with diagram constraints, DSL syntax rules, and concrete example pairs of user code with their corresponding diagram code, thereby grounding the generation process in factual templates rather than unconstrained output.

In summary, by integrating steps shown in FIG. 2 (and described further in FIG. 3 FIG. 6), an automated system for generating and maintaining up-to-date architectural diagram codes can be provided. The system effectively combines continuous code monitoring, resource identification, resource annotation, constraint-based diagram generation, and standardized formatting to provide accurate, consistent, and efficient documentation of complex software architectures. This automated approach minimizes manual effort, reduces the risk of errors, and ensures that architectural diagrams remain current with the evolving codebase, thereby enhancing overall change management and communication within development teams.

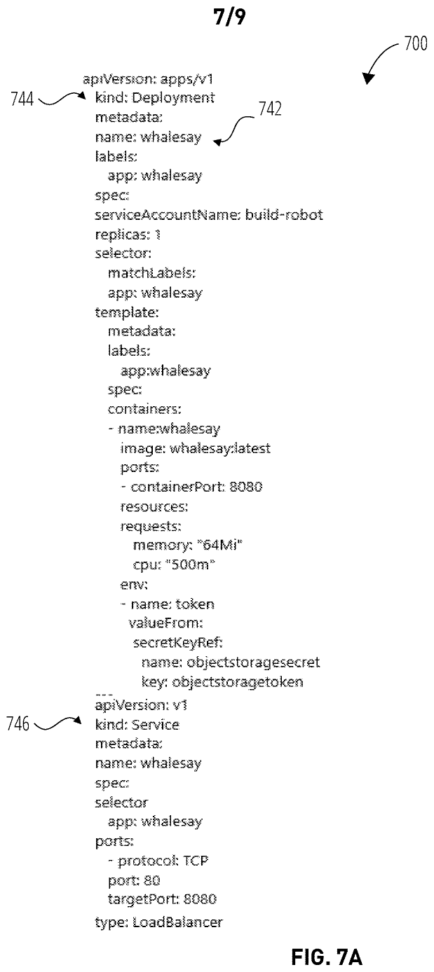

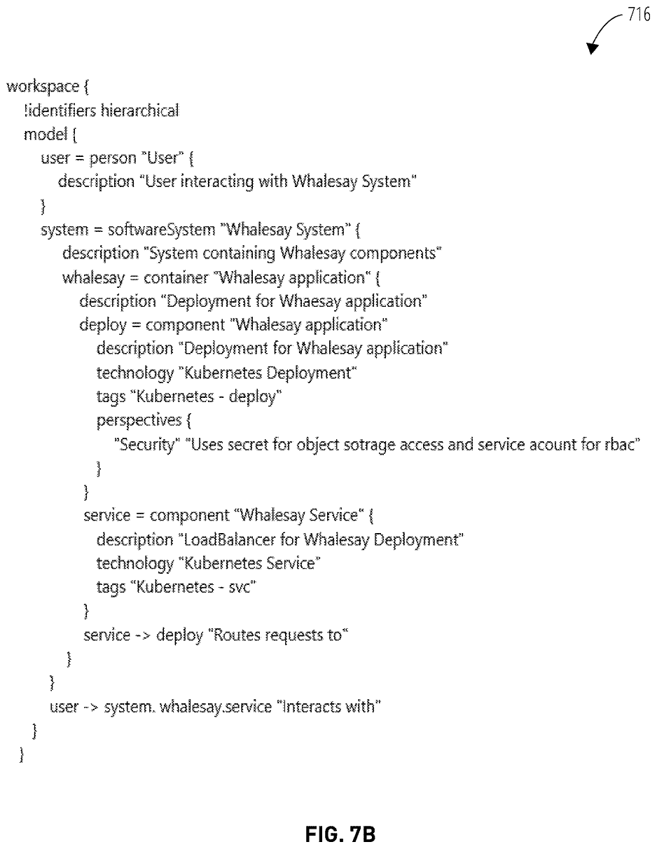

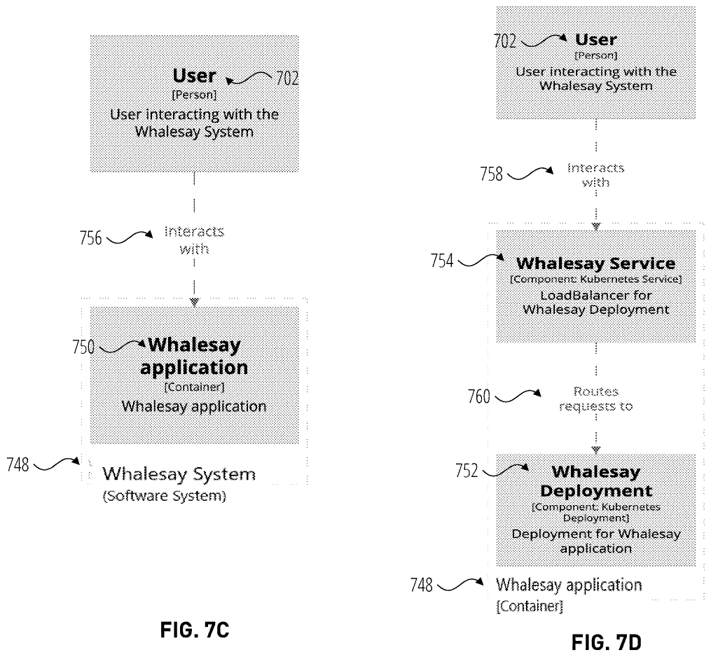

The example shown in FIG. 7A-FIG. 7D, illustrates an input code 700 (in FIG. 7A), output diagram code (in FIG. 7B) and rendered diagrams (that are produced from the diagram code) for a “Whalesay application”.

FIG. 7A illustrates an example of an input code 700. Briefly, an input is the code that exists in code repositories which are used to construct an architecture diagram of the system. In this example, input code 700 is a configuration for deploying a web application called “Whalesay” (742) on a platform cluster that automates the deployment, scaling, and management of containerized applications. An example of such a platform is Kubernetes cluster.

Input code 700 is composed of two main parts: a deployment (744) and a service (746). The deployment 744 defines how to manage a set of identical application instances (Pods) that run the “Whalesay” application. The service 746 exposes the “Whalesay” application to the outside world, allowing external clients to interact with it.

FIG. 7B illustrates an example of an output diagram code 716 based on the input code 700 shown in FIG. 7A. Diagram code 716 is output, for example, at block 612 (in FIG. 6) and can follow a C4 model (Context, Container, Component, and Code) to describe the architecture of the “Whalesay” system in Domain Specific Language (DSL). One or more visual diagrams can be rendered from diagram code 716, using tools that are described below.

A tool can be used that can take the C4 model DSL (that is, diagram code 716) and render it into visual diagrams. An example of such a tool is Structurizr™. Such a tool uses the C4 Code in DSL format as input. The tool processes the input by parsing the DSL and generates a visual representation, that can typically be in SVG or PNG format. The output is a rendered diagram that visually represents the architecture, showing components, relationships, and descriptions as defined in the C4 model.

FIG. 7C and FIG. 7D illustrate two different views of a rendered diagram, based on diagram code 716. The rendered diagram can be displayed on, for example, a user interface. The rendered diagram can be viewed, for example, in two perspectives: a container view, and a component view. FIG. 7C illustrates an example of a container view of an architecture diagram generated from the output diagram code shown in FIG. 7B. In a container view, the “Whalesay Application” is presented without internal details.

In this example the rendered diagram shown in FIG. 7C and FIG. 7D, displays:

User 702, which refers to a person or entity engaging with the “Whalesay” system, indicating where user interaction occurs. Whalesay System 748, which refers to the overall system that houses different components of the application. Whalesay Application 750, which refers to the main application, highlighting its purpose. Whalesay Deployment 752, which represents the Kubernetes Deployment as a component, showing its role in managing replicas of the application. Whalesay Service 754 which refers to a LoadBalancer Service that directs external requests to the appropriate deployment. In FIG. 7C and FIG. 7D the rendered diagram also illustrates interactions, using arrows (756, 758 and 760) that indicate the flow of interactions (756 and 758), such as the user interacting with the service (758) and the service routing traffic to the deployment (760).

FIG. 7D illustrates an example of a component view of an architecture diagram generated from the output diagram code shown in FIG. 7B. The component view shows internal details that are absent in the container view of FIG. 7C. A component view breaks down a container view into its constituent parts. In FIG. 7D, the container view of the “Whalesay Application” shown in FIG. 7C, is broken down into its constituent parts, namely, the “Whalesay Service” and “Whalesay Deployment,” providing a more granular look at the architecture.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive one or more user code files;
identify relevant code from the one or more user code files;
identify one or more architectural resources;
annotate the one or more architectural resources; and
generate an architecture diagram code.

2. The computing apparatus of claim 1, wherein when identifying the relevant code from the one or more user code files, the instructions further configure the apparatus to:
identify one or more code snippets, from the one or more code files, that contain one or more architectural components; and
filter out irrelevant code.

3. The computing apparatus of claim 1, wherein when identifying the one or more architectural resources, the instructions further configure the apparatus to:
cross-reference the relevant code with a list of all architectural resources.

4. The computing apparatus of claim 1, wherein when annotating the one or more architectural resources, the instructions further configure the apparatus to:
apply a set of annotation rules to the one or more architectural resources to obtain one or more annotated architectural resources.

5. The computing apparatus of claim 1, wherein when generating the architecture diagram code, the instructions further configure the apparatus to:
receive the relevant code;
apply predefined diagram constraints to the one or more annotated architectural resources;
apply a set of diagram syntax rules for creation of the architecture diagram code; and
use example pairs of user code and corresponding diagram code in assisting a Large Language Model generate the architecture diagram code.

6. A non-transitory computer-readable storage medium, the computer-readable storage medium including instructions that when executed by a computer, cause the computer to:
receive one or more user code files;
identify relevant code from the one or more user code files;
identify one or more architectural resources;
annotate the one or more architectural resources; and
generate an architecture diagram code.

7. The non-transitory computer-readable storage medium of claim 6, wherein when identifying the relevant code from the one or more user code files, the instructions further configure the computer to:
identify one or more code snippets, from the one or more code files, that contain one or more architectural components; and
filter out irrelevant code.

8. The non-transitory computer-readable storage medium of claim 6, wherein when identifying the one or more architectural resources, the instructions further configure the computer to:
cross-reference the relevant code with a list of all architectural resources.

9. The non-transitory computer-readable storage medium of claim 6, wherein when annotating the one or more architectural resources, the instructions further configure the computer to:
apply a set of annotation rules to the one or more architectural resources.

10. The non-transitory computer-readable storage medium of claim 6, wherein when generating the architecture diagram code, the computer is further configured to:
receive the relevant code;
apply predefined diagram constraints to the one or more annotated architectural resources;
apply a set of diagram syntax rules for creation of the architecture diagram code; and
use example pairs of user code and corresponding diagram code in assisting a Large Language Model generate the architecture diagram code.

11. A computer-implemented method comprising:
receiving, by a processor, one or more user code files;
identifying, by the processor, relevant code from the one or more user code files;
identifying, by the processor, one or more architectural resources;
annotating, by the processor, the one or more architectural resources; and
generating, by the processor, an architecture diagram code.

12. The computer-implemented method of claim 11, wherein identifying the relevant code from the one or more user code files comprises:
identifying, by the processor, one or more code snippets, from the one or more code files, that contain one or more architectural components; and
filtering out, by the processor, irrelevant code.

13. The computer-implemented method of claim 11, wherein identifying the one or more architectural resources comprises:
cross-referencing, by the processor, the relevant code with a list of all architectural resources.

14. The computer-implemented method of claim 11, wherein annotating the one or more architectural resources, further comprises:
applying, by the processor, a set of annotation rules to the one or more architectural resources.

15. The computer-implemented method of claim 11, wherein generating the architecture diagram code comprises:
receiving, by the processor, the relevant code;
applying, by the processor, predefined diagram constraints to the one or more annotated architectural resources;
applying, by the processor, a set of diagram syntax rules for creation of the architecture diagram code; and
using, by the processor, example pairs of user code and corresponding diagram code in assisting a Large Language Model generate the architecture diagram code.
